(19) United States
(12) Patent Application Publication
(10) Pub. No.: US 2004/0218499 A1
(43) Pub. Date: Nov. 4, 2004

(54) Ultra-high density storage and retrieval device using ordered-defect materials and methods of fabrication thereof

(76) Inventor: Alison Chaiken, Fremont, CA (US)

Correspondence Address: HEWLETT-PACKARD COMPANY, Intellectual Property Administration, P.O. Box 272400, Fort Collins, CO, 80527-2400, US

(21) Appl. No.: 10/427,605

(22) Filed: May 1, 2003

(51) Int. Cl. G11B 7/24

(52) U.S. Cl. 369/94; 369/288

(57) ABSTRACT

An ultra-high density data storage and retrieval unit has a data layer for storing and/or retrieving data and a second layer, wherein the data layer and/or the second layer comprise an ordered-defect material. The data layer is a phase-change layer capable of changing between a first state and a second state. The second layer forms a diode with the data layer for detecting a data state of the data layer. A method is provided for forming an ultra-high density data storage and retrieval device comprising forming a data layer for storing and/or retrieving data, and forming a second layer beneath the data layer, wherein the data layer and/or the second layer is an ordered-defect material.

### FIELD OF THE INVENTION

The present invention relates to ultra-high density data recording and detecting systems using thin films some of which are composed of phase-change materials. More particularly, the present invention involves ultra-high density data recording and retrieval devices having ordered-defect semiconductor materials, and methods of fabricating the diode memory cells.

### BACKGROUND OF THE INVENTION

Electronic devices, such as palm computers, digital cameras and cellular telephones, are becoming more compact and miniature, even as they incorporate more sophisticated data processing and storage circuitry. Moreover, types of digital communication other than text are becoming much more common, such as video, audio and graphics, requiring massive amounts of data to convey the complex information inherent therein. These developments have created an enormous demand for new storage technologies that are capable of handling more complex data at a lower cost and in a much more compact package. There is a continued need for increased miniaturization and expanded ability to handle greater quantities of more complex data at a faster speed and in even more compact areas.

Efforts are now underway to enable the storage of data on a scale of ten nanometers (100 angstroms) up to hundreds of nanometers, referred to herein as “ultra-high density data storage” or “atomic resolution storage” (ARS). The goals of this research include developing ultra-high density memory based on field emission devices and phase-change media. One system utilizing this approach is shown in U.S. Pat. No. 5,557,596 granted to Gibson et al. on Sep. 17, 1996 (“Gibson 596 patent”). A plurality of electron emitters are disposed in close proximity to data storage media in order to direct beams of electrons to local data storage areas in the data storage media. The media are mounted on a movable platform to enable each emitter to impact numerous local storage areas. Data is written by emitting electron beams to locally affect a change of state at the data storage areas of the phase-change layer. Data is read by emitting lower energy beams to generate activity at the local storage areas indicative of the state of each storage area. Micromovers, based on micro electromechanical systems (MEMS) technology move the platforms relative to the electron emitters to enable parallel communications with selected storage media areas on the platform.

In the Gibson 596 patent, one data storage device includes a diode having a top layer consisting of a phase-change material that can be reversibly changed between crystalline and amorphous states, or between two crystalline states with different electrical properties. A second layer forms a diode junction with the phase change layer. Data storage bits in the phase-change layer are detected by interrogating a bit with an electron beam while monitoring the current or voltage induced across the diode junction. This induced current or voltage depends on the state of the phase-change layer in the interrogated region.

Several challenges arise in attempting to store data at this level. The processes of information storage and retrieval become increasingly difficult tasks. Reading and writing data in extremely compact and miniature areas with electron and/or light beams presents several limitations. Another major concern is finding reliable and effective materials that have the desired state-change characteristics, including the ability to exhibit contrasts in certain characteristics between states or phases. There are many ways to induce a state change in a storage medium. For example, a change in the topography of the medium, such as a hole or bump, will modify characteristics of the storage medium. A magnetic device can also be used to alter the magnetic characteristics of the storage medium.

Another data state modification method uses a directed energy beam to make a state change. As used herein a “directed energy beam” means a beam of particles, such as electrons, or a beam of photons or other electromagnetic energy, to heat a medium so that it changes states. As used herein, “state” is defined broadly to include any type of physical change of a material, whether from one form to another, such as crystalline to amorphous, or from one structure or phase to another within a form, such as different crystalline structures.

A state change may be accomplished by changing a material from crystalline to amorphous by the application of an electron or light beam. To change from the amorphous to crystalline state, the beam power density is first increased and then slowly decreased. This action melts the amorphous area and then slowly cools it to allow time for the area to anneal into its crystalline state. To change from crystalline to amorphous state, the beam power density is increased to a high level and then rapidly decreased. To read from the storage medium, a lower-energy beam is directed to the storage area to cause activity, such as current flow representative of the state of the storage area.

Yet another problem is the need to develop materials that effectively sense the contrasts in states or phases of phase-change materials, so as to determine the data stored therein. As described in the Gibson 596 patent, a diode may be used having a junction for sensing carrier flow in response to an electron or light beam focused on a data storage memory cell in the phase-change layer. Such diode junctions are utilized for carrier detection in photovoltaic devices, in which light beams impact the phase-change layer, and in cathodovoltaic devices, in which electron beams are directed to the phase-change layer. Photovoltaic devices include phototransistor devices and photodiode devices. Cathodovoltaic devices include cathodotransistor devices and cathododiode devices. In addition, diode junctions may be utilized for carrier flow detection in photoluminescent and cathodoluminescent devices. Reference is made to copending patent application Ser. No. 10/286,010 filed on Oct. 31, 2002 for a further description of the structures and functions of diode junctions in these devices.

In many cases, a phase-change layer forms one part of a diode, combined with another layer to form a diode junction. In this arrangement, the phase-change layer and the other diode layer both need to be composed of materials having electrical properties suitable for generating a desired carrier flow across the diode junction. As used herein, the term “phase-change” refers to a change between two different states in a material. As used herein, the term “carrier flow” refers to either electron current or the flow of holes, depending on whether the diode materials are n-type or p-type. As used herein, the term “materials” includes all kinds and types of compounds, alloys and other combinations of elements.

In other instances, a phase-change layer may be adjacent to but not a part of two other layers that form a diode junction. In this situation, the phase-change layer may be selected from a material primarily because of its superior phase-change characteristics, and the diode layers are chosen primarily for their desirable electrical characteristics.

Various types of junctions may be formed in the context of the above data storage devices, such as heterojunctions, homojunctions, and Schottky junctions, in order to achieve the desired detection results. In heterojunctions, two dissimilar semiconductors are used on opposite sides of the junction. A homojunction is formed by using p-doped and/or n-doped versions of the same semiconductor. In Schottky junctions, a semiconductor is joined at an interface with a metal. In some applications of ultra-high density storage devices, a phase-change layer forms a heterojunction or homojunction with another semiconductor. In other applications, a phase-change semiconductor layer forms a Schottky junction with a metal layer.

An advantage of using heterojunctions is that the doping step may be avoided by using materials that are naturally n-type and p-type to form a diode junction. However, by using different materials, problems may be encountered in establishing good diode junctions. These problems include poor diode interfaces, poor semiconductor surfaces, poor film morphology, grain boundary interference and defect problems and a limited choice of substrate materials, particularly where a heterojunction is formed directly on a semiconductor substrate.

In many cases, some of the above problems are caused by lattice mismatches or incompatible chemistry between different materials used to form the junctions for the device. Poorly chosen heterojunction combinations can cause problems with poor film growth, defects, grain boundaries, interfacial interdiffusion or reaction, and so forth. Lattice mismatch problems can be particularly acute when the bonding between atoms in these materials is via strong covalent or ionic bonds. In other cases, the above problems can result, in part, from dangling or frustrated covalent or ionic bonding sites at surfaces or interfaces. For example, dangling or frustrated bonds can lead to trapping, recombination, and other problems at surfaces and interfaces. Chemical incompatibility problems are most likely when one of the materials is a metal (in the Schottky diode case) or when one of the two semiconductors is elemental like Si.

Many of the above problems can be avoided by forming a homojunction using the same material for both layers of the diode. However, in such case, it is usually necessary to dope one or both layers, in order to form a suitable diode having one layer with p-type characteristics and the other layer with n-type characteristics. Some materials including most chalcogenide semiconductors do not readily accept doping. Furthermore, doping usually increases the fabrication steps needed and the complexity of fabrication to form the diode layers.

Examples of materials being used for a phase-change layer in data storage diodes are indium chalcogenide compounds, such as indium selenide (In₂Se₃) type materials. These compounds have suitable phase change characteristics in transitioning between first and second phases, where both phases exhibit different electrical properties. However, In₂Se₃ is naturally an n-type material and cannot be readily p-doped. Consequently, the other layer of the diode junction must have suitable physical properties to form an acceptable junction interface with In₂Se₃, while having p-type electrical properties to form a suitable carrier flow across the junction. One solution utilizing In₂Se₃ as the data storage layer has been to use a common semiconductor such as Si as the second portion of a heterojunction. Unfortunately, the electrical properties of these mixed diodes have been poor, likely due to recombination centers having defects at the interface.

Another approach has been to use a heterojunction diode based on InSe/GaSe crystalline epilayers grown in silicon wafers. GaSe may be n-doped and has some similarity in structure with InSe to avoid major mismatch problems. GaSe is also relatively heat resistant to the melting temperature of InSe. In this approach, amorphous marks are formed in the crystalline InSe by using high power emission of electron beams to locally melt the InSe which is then quenched into a glassy state. During data detection, the InSe/GaSe diode is reverse-biased to generate a current with gain when illuminated with a low-energy electron beam. The gain is lower over amorphous regions formed in a crystalline InSe layer, enabling detection of data stored in the presence or absence of amorphous regions in the crystalline matrix.

One problem with this approach is that the InSe and GaSe layers in this system are preferably single-crystalline (epitaxial) films, in order to reduce structural defects. Any such defects tend to reduce the overall gain of the device and also form dark areas that mimic amorphous marks, causing false data detection. To avoid such defects, single crystalline epitaxial films are grown. This is a slow and expensive process, typically requiring molecular beam epitaxy or metal-organic chemical vapor deposition methods. In contrast, polycrystalline films are substantially cheaper and faster to fabricate, using sputtering, evaporation or electrodeposition methods.

Furthermore, the properties of InSe and GaSe films are not understood to the same extent as other well known semiconductor materials. It is desirable to use well-studied semiconductors where possible so as to make use of published information about ohmic contacts, passivation layers, doping chemistry and so forth. However, most well-known semiconductors melt at temperatures inaccessible to field emitters or have such a low glass transition temperature that the amorphous state cannot be stabilized. Commonly studied semiconductors such as silicon and GaAs (gallium arsenide) have a simple diamond or zincblende structure. These small-unit-cell structures are a sign of a stable crystalline phase and strong bonding, implying a high melting temperature and low glass transition temperature. Good phase-change media like GeSbTe and InAgTe typically have large unit cells with lower symmetry.

One important specification for data storage devices is the speed of erasure. Magneto-optic recording products failed in part because of their slow overwrite speeds. Typically the crystallization time of the amorphous material limits the overall system speed of phase-change recording devices. Previous work on GeSbTe alloys by J. Gonzalez Hernandez et al. (Appl. Phys. Comm. 11, 557 (1992)) has shown that pseudo-binary mixtures of chalcogenide compounds have the shortest crystallization times. In the GeSbTe system, these alloys are pseudo-binary mixtures of GeTe and Sb₂Te₃. Pseudo-binaries of definite composition had crystallization times that are orders of magnitude smaller than those of random composition. For example, the Ge₂Sb₂Te₅ compound corresponds to a (GeTe)₂—(Sb₂Te₃)₁ pseudobinary, while the compound Ge₁₄Sb₂₉Te₅₇ corresponds to an equal mixture of GeTe and Sb₂Te₃.

Accordingly, materials are needed for forming diode junctions wherein the two layers of the diode have at least some of the following features: (1) the top layer has the ability to change between at least two states, such as crystalline and amorphous, which differ in some characteristic or property so as to be able to store data and provide some way to detect the presence of stored data, and/or (2) the bottom layer is able to maintain a state without being affected by a change in phase or state by the top layer, e.g. if the top layer is changed by the application of heat, the bottom layer would have a significantly higher melting temperature than the top layer, and (3) the diode layers have sufficiently different electrical characteristics, such as different p-type and n-type materials, to provide a suitable rectifying junction so as to generate a flow of carriers across the junction. Moreover, a medium film is needed for diode detection applications that may be polycrystalline with electrical properties that are relatively insensitive to defects. In addition, it may be important for the layers to have similar structure and chemistry so as to form an acceptable junction interface with a minimum of defect and mismatch problems.

### SUMMARY OF THE INVENTION

The present invention utilizes a class of materials called CIS materials for one or more layers in ultra-high data storage memory cell diodes. This class of materials is based on compounds of various types of copper indium selenium (Cu—In—Se). As used herein, the terms “CIS,” “CIS compound” or “CIS material” refer to a compound having any ratio of CuInSe, such as CuInSe₂, including but not limited to gallium-doped CIS (CIGS). The term “CIGS” refers to CuInSe doped with gallium to form various stoichiometric and off-stoichiometric compounds of copper indium gallium selenide including but not limited to (Cu(In,Ga)Se₂) and Cu₂Se—In₂Se₃ pseudo-binaries.

Complex CIS compounds may also be referred to as ordered-defect compounds. As used herein, the terms ordered-defect compound, ordered-defect material or ODC refer to CIS materials having defects throughout their structure wherein the defects occur in an ordered fashion and are typically off-stoichiometric, not having a simple “CIS-112” CIS ratio like CuInSe₂ or a simple “CIGS-1112” ratio like Cu(InGa)Se₂. As used herein, the term “off-stoichiometric” refers to CIS materials that are Cu-poor or In-poor but are still relatively stable and useful. CIS materials have substantial tolerance for these off-stoichiometric ratios because of the relatively low formation energies required.

In one embodiment of the present invention, an ultra-high density data storage and retrieval unit has a data layer for storing and/or retrieving data and a second layer, wherein the data layer and/or the second layer comprise an ordered-defect material.

In another embodiment, an ultra-high density data storage and retrieval unit has a memory cell diode, comprising a phase-change layer capable of changing between a first state and a second state to store data. A second layer adjacent to the phase-change layer forms the diode with the phase-change layer for detecting a state of the phase-change layer. The phase-change layer and/or the second layer comprise an ordered-defect material.

Another embodiment of the present invention involves an ultra-high density data storage and retrieval unit including a memory cell diode having a structure selected from a group consisting of the following configurations: ODC film/ODC film, ODC film/non-ODC film, non-ODC film/ODC film. The ODC film is an ordered-defect material, and the order of listing indicates the deposition order of the two layers.

Still another embodiment comprises a method for forming an ultra-high density data storage and retrieval device. A data layer is formed for storing and/or retrieving data, and another layer is formed beneath the data layer. The data layer and/or the other layer comprise an ordered-defect material.

Yet another embodiment comprises a method for forming an ultra-high density data storage and retrieval device comprising forming a buffer layer on a silicon substrate, forming a counter-electrode semiconductor layer on the buffer layer, and forming a data layer on the counter-electrode semiconductor layer. The counter-electrode semiconductor layer and/or the data layer are composed of an ordered-defect material.

Other aspects and advantages of the present invention will become apparent from the following detailed description, which, when taken in conjunction with the accompanying drawings, illustrates by way of example the principles of the invention.

### BRIEF DESCRIPTION OF THE DRAWINGS

FIG. 1 is a partial side view of a prior art data storage system;

FIG. 2 is a cross-sectional plan view of the storage system shown in FIG. 1;

FIG. 3 is a schematic view of a portion of the storage system shown in FIG. 1;

FIG. 4 is a phase diagram showing regions of stability for various CIS materials and related compounds, regarding embodiments of the present invention;

FIG. 5 is a ternary phase diagram showing a pseudo-binary line for ternary compounds regarding embodiments of the present invention;

FIG. 6 is a schematic side view of a diode structure according to an embodiment of the present invention;

FIG. 7 is a schematic side view of a diode structure according to another embodiment of the present invention; and

FIG. 8 is a schematic side view of a diode structure according to another embodiment of the present invention.

The same numerals in the figures are assigned to similar elements in all the figures. Embodiments of the invention are discussed below with reference to the figures. However, those skilled in the art will readily appreciate that the detailed description given herein with respect to these figures is for explanatory purposes as the invention extends beyond these limited embodiments.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

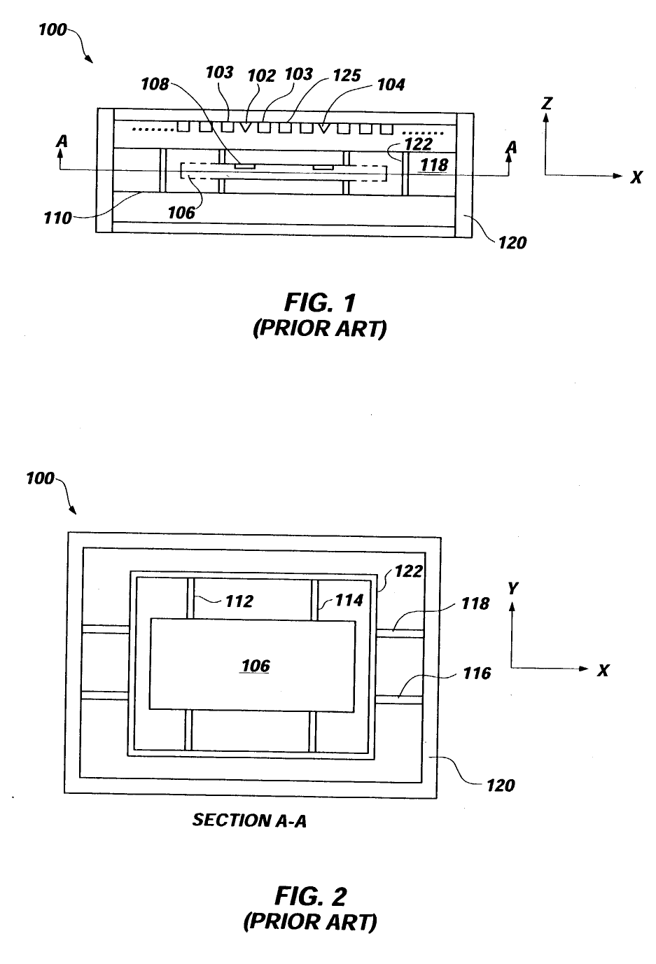

Ultra-high Density Data Storage and Retrieval Devices. By way of background, a prior art application for utilizing the data storage and detection device of the present invention will be discussed. Specifically, FIG. 1 shows a cross-section of an ultra-high density data storage system 100 having electron emitters 102 and 104, a phase-change data storage medium 106 and a micromover unit 110. Electron emitter 102 and 104 are mounted above the storage medium 106, that has a number of storage areas, such as 108, that are impacted by electron beams from the emitters. Micromover 110 is connected to the storage medium 106 and moves it relative to the emitters 102, 104, so that each emitter can impact a number of different data storage areas. In one specific embodiment, each storage area is used for storing one bit of information.

As the micromover 110 scans the medium 106 in the X-Y directions to different locations, each emitter is positioned above different storage areas. With the micromover 110, an array of field emitters can scan over the storage medium. Alternatively, a micromover 110 may be connected to the emitters to move the emitters relative to the storage medium, in order to achieve a similar scanning effect.

FIG. 2 is a top view of the cross section A-A in FIG. 1, showing the micromover 110 fabricated to scan the medium 106 in the X and Y directions. The storage medium 106 is supported by two sets of thin-walled micro-fabricated flexible beams or springs 112 and 114 which flex to allow the medium 106 to move in the X direction with respect to a supporting frame 122. A second set of springs 116 and 118 are connected between the supporting frame 122 and the outer casing 120 and flex to allow the medium 106 and frame 122 to move in the Y direction with respect to the casing 120. The field emitters scan over the medium, or the medium scans over the field emitters in the X-Y directions by electrostatic, electromagnetic or piezoelectric means known in the art.

Writing on the data storage medium 106 is accomplished by temporarily increasing the power density of the electron beam current to modify the surface state of the storage area. Reading is carried out by providing electron beams with a decreased power density and observing the effect of the storage area on the electron beams, or the effect of the electron beams on the storage area. A storage area that has been modified can represent a bit 1, and a storage area that has not been modified can represent a bit 0, or the storage area may be modified to different degrees to represent more than two bits.

Reference is made to the Gibson 596 patent for more detail regarding the ultra-high data storage device shown in FIGS. 1 and 2, including the action of the emitters, micromovers and storage medium and the functions of writing and reading data.

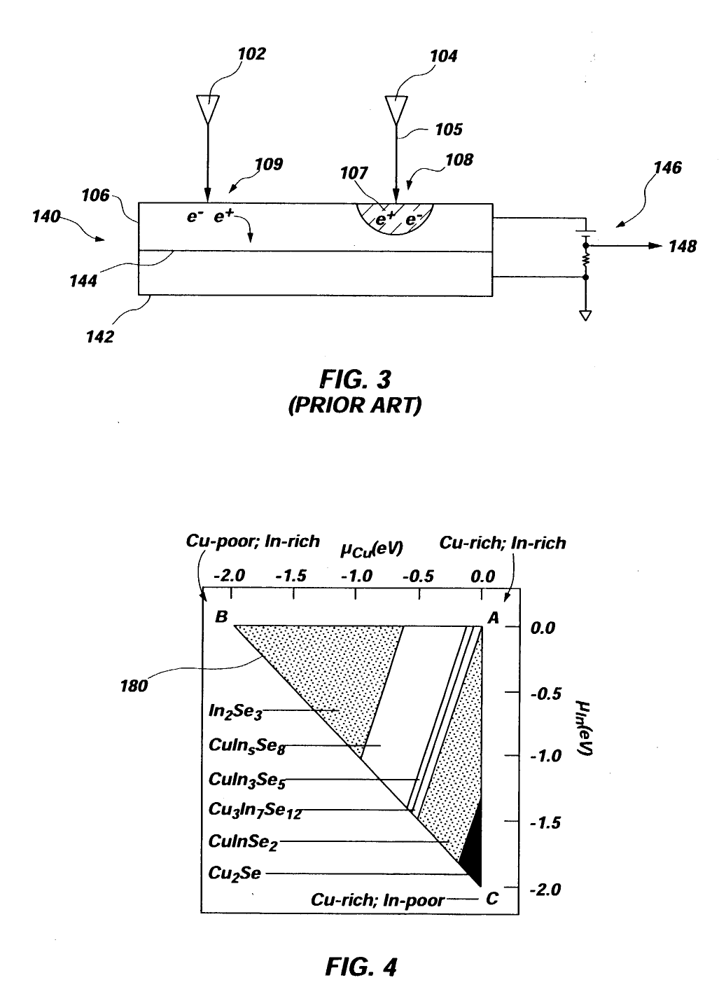

The present invention is concerned with diodes and diode materials used in conjunction with a phase-change layer to detect the state of the data storage cells in the phase-change layer. FIG. 3 shows a simplified diode structure 140 comprising the phase-change layer 106 described above and a second diode layer 142 forming a diode junction 144 at the interface of the two layers. Typically, phase-change layer 106 and second diode layer 142 have different electrical characteristics, to encourage the movement of carriers across the junction. For example, phase change layer 106 may be n-type and second diode layer 142 may be p-type. Doping may be used to change or enhance the electrical characteristics of each layer. An external circuit 146 is connected to the diode to impress a voltage across the junction so as to create a bias, either in a reverse direction or in a forward direction, depending on the needs of the circuit. An output 148 is generated by circuit 146 and is representative of the magnitude of carrier flow across junction 144. The term “pn characteristics” as used herein refers to the p-type or n-type state of a material, whether formed naturally or by doping.

The presence of a built-in field is a necessary but not sufficient condition for favorable electrical properties in a diode. A built-in field occurs when two materials in contact have different work functions. The work function of a material is the energy difference between a material's Fermi energy and the vacuum. P- and n-doped versions of a given semiconductor necessarily have different work functions since the Fermi level will be close to the valence band for a p-type semiconductor and close to the conduction band for an n-type semiconductor. Alternately, the carrier type of both layers of a diode junction may be the same, but the layers differ from each other in work function to the extent that the junction between the layers has a built-in field. When two materials that are both p-type (or both n-type) have sufficiently different work functions and these materials are placed in contact, their vacuum levels align and charge carriers diffuse from one material to the other. This motion of charge carriers leads to a built-in electrical field that causes the materials' energy bands to bend.

As explained above, the altered state of each storage area 108 may be detected in various ways. One approach is to store bits at data storage areas in the phase-change material by locally altering the surface of the storage medium 106 in such a way that the collection efficiency for minority carriers generated near the altered data storage area 108 is different from that of an unaltered data storage area 109. The term “collection efficiency for minority carriers” is defined as the fraction of minority carriers generated by incident electrons that cross the diode junction 144 when it is reverse biased by external circuit 146. External circuit 146 is only exemplary of the concept explained above. The actual external circuit used may be different and more complex, but still provides a bias across the diode junction and measures the current across the junction.

The reading or detection operation is done by the field emitter 104 directing a narrow beam of electrons 105 or electromagnetic radiation, such as light, onto the surface of phase change layer 106 at data storage area 108. The incident beams excite electron-hole pairs 107 near the surface of the storage area 108. The diode 140 is reversed-biased by external circuit 146 so that the minority carriers that are generated by the incident electrons are swept toward the diode junction 144. Electrons that reach the junction 144 will be swept across the junction. In other words, minority carriers that do not recombine with majority carriers before reaching the junction are swept across the junction, causing a current to flow in the external biasing circuit 146.

Writing onto diode 140 is accomplished by increasing the power density of the electron or optical beam 105 enough to locally alter some property of the diode at storage area 108, such as collection efficiency of minority carriers. For example, the recombination rate in a written area 108 could be increased relative to an unwritten area 109 so that the minority carriers 107 generated in the written area 108 have an increased probability of recombining with majority carriers before they have a chance to reach and cross the junction 144. Hence, a smaller current flows in the external circuit 146 when the read beam 105 is incident upon a written area 108 than when it is incident upon the unwritten area 109.

Conversely, one may also start with a diode structure having a high recombination rate, and then write bits by locally reducing the recombination rate. The magnitude of the current resulting from the minority carriers depends on the state of the storage area, and the current magnitude is represented by the output signal 148 to indicate the nature of the sensed data bit.

Ultra-high Data Storage and Retrieval Media. With the foregoing background, the present invention is concerned with suitable media or materials for fabricating diode memory cells having phase-change media diode layer for storing and detecting data. The media may include many different types of compounds and materials that have suitable phase-change characteristics for the data layer and that have suitable structural and electrical characteristics to form a suitable diode for detecting the data states of the memory cells.

A class of materials called CIS materials has been determined to have useful characteristics for one or more layers in ultra-high data storage memory cell diodes. As discussed above, this class of materials is based on compounds of various types of copper indium selenium (Cu—In—Se). The compounds are referred to as “CIS,” “CIS compound” or “CIS material” or “CIGS” if doped with gallium.

CIS compounds have a number of advantages. They may be produced as polycrystalline films, which are less expensive and faster to fabricate than slow and expensive epitaxy methods to form single crystalline layers. Polycrystalline films may be produced utilizing sputtering, evaporation or electrodeposition during manufacture. Further, at least some CIS films have electrical properties that are relatively insensitive to defects and may be produced with higher yield over that of some epitaxial films.

CIS materials have gained widespread use as absorber layers in high-efficiency photovoltaic power generation devices. These solar cells are made by combining CIS materials with CdTe or CdS counterelectrodes. The excellent electrical properties of polycrystalline CIS materials make them promising candidates for use in ultra-high density memory cells for several reasons. The growth of CIS materials is well studied, and their electrical properties are suitable and well-known.

CIS materials may be grown as n- or p-type and may be doped to enhance their electrical conductivity. They also have forgiving defects in polycrystalline form. Further, the low-symmetry, defected crystal structures of the Cu₂Se—In₂Se₃ pseudobinaries suggest that some of the CIS materials may have a high enough glass transition temperature to quench into the amorphous state and serve as good phase-change media. Most of the phases in the CIS system have tetragonal crystal structures, and several have large unit cells. The CuInSe₂ compound has excellent electrical properties, but also has the more symmetric chalcopyrite crystal structure and a high melting temperature. See J. Folmer et al., J. Electrochem. Soc. 132, 1319 (1985).

In ultra-high density data storage devices, CIS compounds can be useful for forming both the top layer and the bottom layer of a memory cell diode. Certain chalcogenide compounds form high collection-efficiency diodes with CIS materials, such as InSe, In₂Se₃ and GaSe, in some cases as a phase-change layer and in other cases as a bottom diode layer. U.S. Pat. No. 5,385,806 (Ohno et al.) considered several ternary compounds for the optical recording of data, including the chalocopyrite CuInSe₂. However the recording method envisioned by Ohno was all-optical, and did not include heterojunction detection of carriers, nor were Cu₂Se—In₂Se₃ films explicitly considered.

As a bottom layer, CIS compounds having the chalocopyrite structure, such as CuInSe2 or CuInGaSe2, may be used. Such structures are relatively stable and are not affected by typical melting temperatures needed to change the state or phase of the top layer. See a copending application, [HP 10020-1669] entitled “Ultra-high Density Data Storage Device Using Phase Change Diode Memory Cells and Methods of Fabrication Thereof” which describes in greater detail the use of CIS compounds as the bottom layer in a memory cell diode of the type discussed here. Alternately, a GaSe layer may be used, as previously discussed.

For both top and bottom layers, more exotic or complex CIS structures are also desirable for forming one or both layers in memory cell diodes. As mentioned above, these complex CIS compounds may also be referred to as an “ordered-defect compound,” “ordered-defect material” or “ODC.” These terms refer to CIS materials having defects throughout their structure wherein the defects occur in an ordered fashion and are typically off-stoichiometric, not having a simple “CIS-112” ratio like CuInSe₂ or a simple “CIGS-1112” ratio like Cu(InGa)Se₂.

Referring to FIG. 4, a phase diagram is provided with a line 180 showing regions of stability for the CuIn₃Se₅, CuIn₅Se₈ and Cu₃In₇Se₁₂ pseudobinary compounds. (The region of stability for Cu₃In₅Se₉ is not shown.) According to Zhang et al (“Defect physics of the CuInSe₂ chalcopyrite semiconductor,” Phys. Rev. vol. 57, 9642 (1998)), these compounds are stable because they contain ordered arrays of defects consisting of two Cu vacancies plus one In antisite defect. These defect triplets are charge-neutral and do not contribute a deep level recombination center. This self-passivation of defects is a partial explanation of why polycrystalline CIS materials can be made into relatively efficient photovoltaic devices.

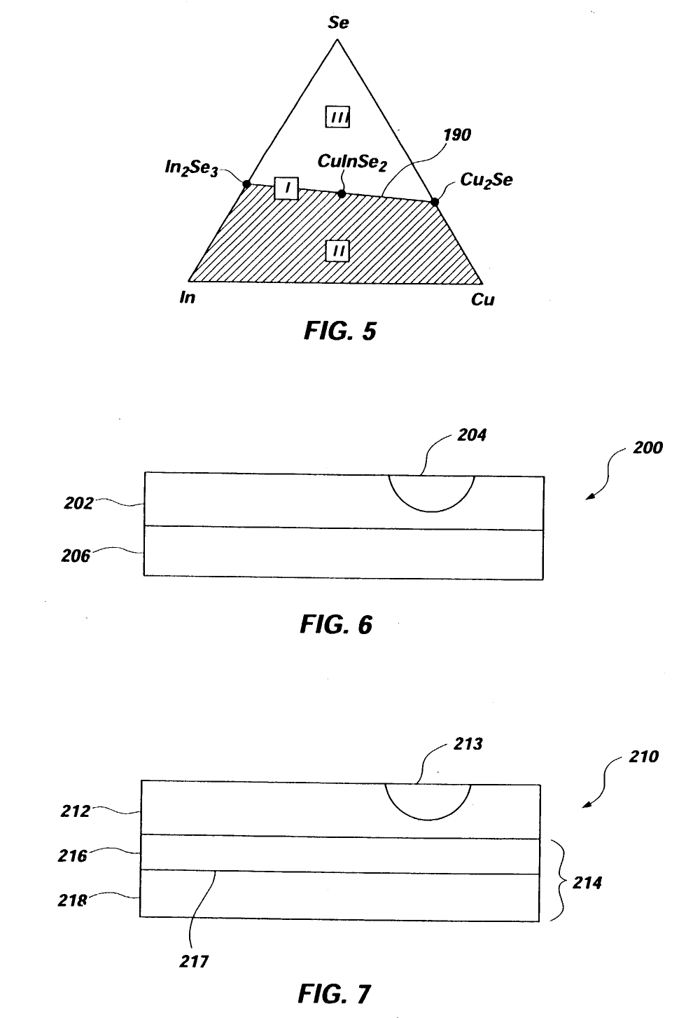

FIG. 5 is a ternary phase diagram showing that ODC compounds tend to be found along a pseudo-binary line 190. Based on their complex crystal structures, these phases are expected to have high enough glass transition temperatures to enable melted regions to be quenched into amorphous bits. Based on the analogy with GeTe—Sb₂Te₃ pseudobinaries, the CIS materials found on the Cu₂Se—In₂Se₃ tie line are expected to have shorter crystallization times than other ternary compounds in the Cu—In—Se system, like CuIn₇Se₁₂ or Cu₄In₉Se₁₆.

In pseudo-binary systems there are several phases that are ordered-defect compounds, notably CuIn₃Se₅, CuIn₅Se₈, Cu₂In₄Se₇ and Cu₃In₅Se₉. As mentioned above, the CIS compounds may also include quaternary compounds Cu—In—Ga—Se (CIGS). As used herein, the term “Selected ODC Group” includes the following CIS compounds: (1) naturally n-type —CuIn₃Se₅ (“CIS-135”) and CuIn₅Se₈ (“CIS-158”), and (2) p-type —Cu₂In₄Se₇ (“CIS-247”) and Cu₃In₅Se₉ (“CIS-359”). The Selected ODC Group also includes the foregoing compounds with gallium-doping, as well as compounds having the generalized formula Cu(In₁₋ₓGaₓ)Se₂.

Data storage and retrieval devices having a plurality of memory cells may be are fabricated using heterojunction and homojunction diodes based on the ODC media mentioned above. For example ODC heterojunction diodes may be formed from two or more of the following materials in various combinations: InSe, GaSe, CuInSe₂, CIS-135, CIS-158, CIS-247, CIS-359 and Ga-doped versions of the preceding. The following ODC diode combinations have been found to be effective and are referred to herein as the “Selected ODC Diode Group”:

InSe/247 or InSe/359

135/GaSe or 158/GaSe

135/CuInSe₂ or 158/CuInSe₂

247/In₂Se₃ or 359/In₂Se₃

GaSe/Cu(In₁₋ₓGaₓ)Se₂

247/Cu(In₁₋ₓGaₓ)Se₂ or 359/Cu(In₁₋ₓGaₓ)Se₂

Where 135 is CuIn₃Se₅, 158 is CuIn₅Se₈, 247 is Cu₂In₄Se₇, and 359 is Cu₃In₅Se₉.

Other ODC compound combinations may also be effective as diodes besides those described in the Selected ODC Group and are meant to be included within the scope of the present invention, including a memory cell diode with a structure selected from a group consisting of the following configurations:

ODC film/ODC film

ODC film/non-ODC film

non-ODC film/ODC film

wherein the ODC film is an ordered-defect material and where the order of listing indicates the deposition order of the two layers.

FIG. 6 shows a schematic side view of a diode configuration 200 in accordance with one embodiment of the present invention is shown. A phase-change layer 202 is composed of a suitable phase-change media that can be reversibly changed from an insulating (amorphous) to a semiconducting (crystalline) state by heating and cooling it at suitable rates. As discussed above, useful materials for the phase-change media include InSe, GaSe, In₂Se₃ and ODC pseudo-binaries having ratios CIS-135, CIS-158, CIS-247, and CIS-359. Melting temperatures, in degrees, for these compounds were found to be in the vicinity of the following: InSe—660 C, In₂Se₃—900 C, GaSe—950 C, CuInSe₂—1002 C, and ODC pseudobinaries—about 900 C.

When the phase-change layer 202 is changed from an amorphous state to a crystalline state at a storage area 204, its electrical properties may significantly change. Accordingly, the number of carriers swept across the diode junction may be significantly different between crystalline and amorphous states.

A second diode layer 206 is disposed below the phase-change layer 202 to form a diode junction 207. As discussed above, useful materials for the second diode layer 206 include GaSe, In₂Se₃, CuInSe₂, Cu(In₁₋ₓGaₓ)Se₂ and ODCs having ratios CIS-247 and CIS-359.

Referring to FIG. 7, an ultra-high density memory storage diode 210 is shown in which a phase-change layer 212 is separate from a diode 214, composed of diode layers 216 and 218. A diode junction 217 lies between the diode layers and is not in contact with the phase-change layer 212. In this embodiment, the selection of the phase-change layer 212 can be focused entirely on media that have excellent phase-change characteristics for local memory cell regions and that have significantly different carrier generation or recombination characteristics in different states or phases. The two diode layers 216 and 218 below the phase-change layer 212 are not limited to phase-change requirements but can be focused on various characteristics that are important for suitable functioning of the diode, such as pn characteristics and doping.

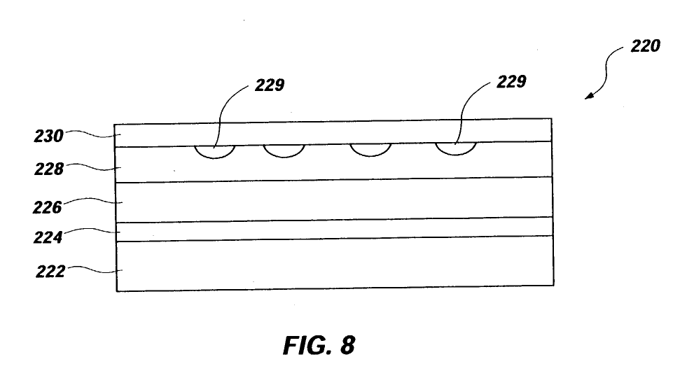

Looking at FIG. 8, in one embodiment of the present invention, an ultra-high density memory storage diode 220 may be fabricated by depositing one or more layers of ODC materials on a substrate where the ODC materials serve as the diode materials. For example, a given substrate 222 is selected, typically silicon or silicon dioxide, upon which a buffer layer 224 is fabricated. On top of the buffer layer 224, is formed a counter electrode semiconductor layer 226, such as GaSe or CuInSe₂. Next a phase-change data layer 228, including an ODC, is formed on the counter electrode semiconductor layer 226, on which to form data storage regions 229. After the data layer 228 is fabricated, a cap layer 230 may, optionally, be formed thereon. Within this structure, certain layers may include a dopant introduced into a selected layer.

Use of CIS pseudo-binaries in an ARS media heterojunction device provides greater design flexibility in fabrication. For example, an ODC/CuInSe₂ heterojunction can be produced by sputtering, evaporation or chemical vapor deposition and has useful electrical properties in polycrystalline form. ODC compounds may also be used in conjunction with GaSe or InSe in diode-formed heterojunctions. In addition, GaSe, grown epitaxially on Si(111), may be utilized as a buffer layer with heterojunction diodes. The interfaces between these two chemically related and structurally similar compounds provide good electrical quality.

It is to be understood that the above-referenced arrangements are illustrative of the application for the principles of the present invention. It will be apparent to those of ordinary skill in the art that numerous modifications can be made without departing from the principles and concepts of the invention as set forth in the claims.

What is claimed is:

1. An ultra-high density data storage and retrieval unit having a data layer for storing and/or retrieving data and having a second layer, wherein the data layer and/or the second layer comprise an ordered-defect material.

2. The ultra-high density data storage and retrieval unit of claim 1, wherein the data layer is a phase-change layer capable of changing between a first state and a second state.

3. The ultra-high density data storage and retrieval unit of claim 2, wherein the second layer forms a diode with the data layer for detecting a data state of the data layer.

4. The ultra-high density data storage and retrieval unit of claim 3, wherein the diode is formed with a heterojunction between the second layer and the phase-change layer.

5. The ultra-high density data storage and retrieval unit of claim 2, wherein the phase-change layer is capable of changing states in response to heat from an electron beam or an optical beam.

6. The ultra-high density data storage and retrieval unit of claim 5, wherein the phase-change layer is capable of changing states between an amorphous state and a crystalline state.

7. The ultra-high density data storage and retrieval unit of claim 5, wherein the phase-change layer has a melting point substantially lower than a melting point of the second layer.

8. The ultra-high density data storage and retrieval unit of claim 1, wherein one of the layers is an n-type semiconductor and one is p-type, or wherein the layers differ from each other in work function to the extent that the junction between the layers has a built-in field.

9. The ultra-high density data storage and retrieval unit of claim 8, wherein the data layer and/or the second layer are p-doped or n-doped.

10. The ultra-high density data storage and retrieval unit of claim 1, wherein the ordered-defect material is selected from a group consisting of the following:
CuIn₃Se₅, CuIn₅Se₈, Cu₂In₄Se₇, Cu₃In₅Se₉, the foregoing compounds with gallium-doping, and compounds having the generalized formula Cu(In₁₋ₓGaₓ)Se₂.

11. The ultra-high density data storage and retrieval unit of claim 3, wherein the diode is selected from a group consisting of the following:
InSe/247 or InSe/359
135/GaSe or 158/GaSe
135/CuInSe₂ or 158/CuInSe₂
247/In₂Se₃ or 359/In₂Se₃
GaSe/Cu(In₁₋ₓGaₓ)Se₂
247/Cu(In₁₋ₓGaₓ)Se₂ or 359/Cu(In₁₋ₓGaₓ)Se₂
Where 135 is CuIn₃Se₅, 158 is CuIn₅Se₈, 247 is Cu₂In₄Se₇, and 359 is Cu₃In₅Se₉.

12. An ultra-high density data storage and retrieval unit having a memory cell diode, comprising:
(a) a phase-change layer capable of changing between a first state and a second state to store data; and
(b) a second layer adjacent to the phase-change layer and forming the diode with the phase-change layer for detecting a state of the phase-change layer, the phase-change layer and/or the second layer comprising an ordered-defect material.

13. The ultra-high density data storage and retrieval unit of claim 12, wherein the memory cell diode is selected from a group consisting of photodiodes, cathododiodes, phototransistors, cathodotransistors, photoluminescent devices and cathodoluminescent devices.

14. The ultra-high density data storage and retrieval unit of claim 12, wherein at least one of the ordered-defect material layers has a polycrystalline structure.

15. An ultra-high density data storage device using phase-change diode memory cells, and having a plurality of emitters for emitting directed energy beams, a layer for forming multiple data storage cells and at least two layers forming a diode structure for detecting a memory or data state of the storage cells, the device comprising:
(a) a phase-change layer capable of changing states in response to the beams from the emitters; and
(b) a second layer forming one layer in the diode structure, the phase-change layer and/or the second layer comprising an ordered-defect material.

16. The data storage device according to claim 15, wherein the phase-change layer and the second layer form the diode structure.

17. The data storage device according to claim 15 wherein the phase-change layer is capable of changing states between crystalline and amorphous in response to heat from an electron beam or a photon beam.

18. The data storage device according to claim 16, wherein the phase-change layer has a melting point substantially lower than the melting point of the second layer.

19. The data storage device according to claim 15, wherein the phase-change layer and the second layer have opposite pn characteristics.

20. The data storage device according to claim 15, wherein the phase-change layer and the second layer are polycrystalline.

21. An ultra-high density data storage and retrieval unit including a memory cell diode having a layered structure selected from a group consisting of the following configurations:
ODC film/ODC film
ODC film/non-ODC film
non-ODC film/ODC film
wherein (1) the ODC film is an ordered-defect material and where the order of listing indicate a deposition order of the two layers.

22. The ultra-high density data storage and retrieval unit of claim 21, wherein the ordered-defect material is selected from a group consisting of the following:
CuIn₃Se₅, CuIn₅Se₈, Cu₂In₄Se₇, Cu₃In₅Se₉, the foregoing compounds with gallium-doping, and compounds having the generalized formula Cu(In₁₋ₓGaₓ)Se₂.

23. The ultra-high density data storage and retrieval unit of claim 21, wherein the diode is selected from a group consisting of the following:
InSe/247 or InSe/359
135/GaSe or 158/GaSe
135/CuInSe₂ or 158/CuInSe₂
247/In₂Se₃ or 359/In₂Se₃
GaSe/Cu(In₁₋ₓGaₓ)Se₂
247/Cu(In₁₋ₓGaₓ)Se₂ or 359/Cu(In₁₋ₓGaₓ)Se₂
Where 135 is CuIn₃Se₅, 158 is CuIn₅Se₈, 247 is Cu₂In₄Se₇, and 359 is Cu₃In₅Se₉.

24. A method for forming an ultra-high density data storage and retrieval device comprising forming a data layer for storing and/or retrieving data, and forming a second layer beneath the data layer, wherein the data layer and/or the second layer comprise an ordered-defect material.

25. The method according to claim 24, wherein the data layer and the second layer are disposed adjacent to each other to form a diode for detecting a data state of the data layer.

26. The method according to claim 26, wherein the diode forms a heterojunction.

27. The method according to claim 24, wherein the data layer is formed using a phase-change medium capable of changing between a first state and a second state.

28. The method according to claim 24, wherein the phase-change layer is capable of changing states in response to heat from a directed energy beam.

29. The method according to claim 28, wherein the phase-change layer is capable of changing states between an amorphous state and a crystalline state.

30. The method according to claim 28, wherein the phase-change layer has a melting point substantially lower than the melting point of the second layer.

31. The method according to claim 24, wherein one of the two layers is n-type and the other is p-type.

32. The method according to claim 24, wherein the two layers differ in work function from each other to the extent that the junction between the two layers has a built in field.

33. The method according to claim 31, wherein the data layer and/or the second layer is p-doped or n-doped.

34. The method according to claim 24, wherein the ordered-defect material is selected from a group consisting of the following:
CuIn₃Se₅, CuIn₅Se₈, Cu₂In₄Se₇, Cu₃In₅Se₉, the foregoing compounds with gallium-doping, and compounds having the generalized formula Cu(In₁₋ₓGaₓ)Se₂.

35. The method according to claim 25 wherein diode is selected from a group consisting of the following:
InSe/247 or InSe/359
135/GaSe or 158/GaSe
135/CuInSe₂ or 158/CuInSe₂
247/In₂Se₃ or 359/In₂Se₃
GaSe/Cu(In₁₋ₓGaₓ)Se₂
247/Cu(In₁₋ₓGaₓ)Se₂ or 359/Cu(In₁₋ₓGaₓ)Se₂
Where 135 is CuIn₃Se₅, 158 is CuIn₅Se₈, 247 is Cu₂In₄Se₇, and 359 is Cu₃In₅Se₉.

36. The method according to claim 24, wherein the ordered-defect material is polycrystalline.

37. A method for forming an ultra-high density data storage and retrieval device comprising:
(a) forming a buffer layer on a silicon substrate;
(b) forming a counter-electrode semiconductor layer on the buffer layer; and
(c) forming a data layer on the counter-electrode semiconductor layer, wherein the counter-electrode semiconductor layer and/or the data layer is composed of an ordered-defect material.

38. The method according to claim 37, wherein the counter-electrode semiconductor layer and/or the data layer is doped with p- and/or n-dopant.
